(19) United States
(12) Patent Application Publication
(10) Pub. No.: US 2016/0336113 A1
(43) Pub. Date: Nov. 17, 2016

(54) Method for Producing a Capacitor, Capacitor and Use Thereof

(71) Applicant: SIEMENS AKTIENGESELLSCHAFT, München (DE)

(72) Inventors: Richard Matz, Bruckmuehl (DE); Steffen Walter, Oberpframmem (DE)

(73) Assignee: Siemens Aktiengesellschaft, Muenchen (DE)

(21) Appl. No.: 15/110,785

(22) PCT Filed: Dec. 9, 2014
(86) PCT No.: PCT/EP2014/077028

§ 371 Date: Jul. 11, 2016

(30) Foreign Application Priority Data
Jan. 10, 2014 (DE) 10 2014 200 318.0

(51) Int. Cl. H01G 4/28; C23C 4/134; C23C 4/12; H01G 4/12; H01G 4/30

(52) U.S. Cl. CPC H01G 4/28; H01G 4/1209; H01G 4/30; C23C 4/12; C23C 4/134

(57) ABSTRACT

A capacitor, a method for producing a capacitor, and the use of a capacitor of for producing an electric cable, a coaxial cable and/or a resonant heating cable are disclosed. The method may be suitable for mass production of a capacitor, e.g., a cylindrical capacitor. The method may include alternately coating a main member with dielectric and electrically conducting layers using thermal spraying and/or spraying, and then sintering the resulting structure. The resulting capacitor may provide advantageous design variability, e.g., with respect to the capacitance and breakdown voltage, as well as excellent temperature resistance.

### CROSS-REFERENCE TO RELATED APPLICATIONS

This application is a U.S. National Stage Application of International Application No. PCT/EP2014/077028 filed Dec. 9, 2014, which designates the United States of America, and claims priority to DE Application No. 10 2014 200 318.0 filed Jan. 10, 2014, the contents of which are hereby incorporated by reference in their entirety.

### TECHNICAL FIELD

The invention relates to a method for producing a capacitor. The invention furthermore relates to a capacitor and to the use of such a capacitor for producing a power cable, a coaxial cable and/or a resonant heating line.

### BACKGROUND

Applications in power electronics increasingly require passive components which can be operated at high voltages, currents and temperatures, for example at 10 kV, 100 A and 500° C. In particular, there is a need for capacitive components which have a charge capacitance up into the pF range and can be used under such extreme operating conditions.

### SUMMARY

One embodiment provides a method for producing a capacitor, in particular a cylindrical capacitor, comprising the following steps: (a) providing a main body; (b) producing a layer system on the main body, the layer system comprising at least two electrically conductive layers in each case galvanically isolated from one another by at least one dielectric layer, the at least one dielectric layer comprising at least one ceramic ply applied by thermal spraying; and (c) sintering the layer system.

In one embodiment, the at least one dielectric layer surrounds the main body once along the circumference.

In one embodiment, the at least one dielectric layer is applied by plasma spraying.

In one embodiment, at least one of the electrically conductive layers is applied by a thermal spraying method.

In one embodiment, at least one of the electrically conductive layers is applied as a conductive paste and/or as a conductive dispersion.

In one embodiment, the main body is removed before the layer system is sintered.

In one embodiment, the layer system is processed before being sintered, but after the main body has been removed.

In one embodiment, the layer system is structured after the main body has been removed.

Another embodiment provides a capacitor, e.g., a cylindrical capacitor, comprising a layer system, which has at least two electrically conductive layers in each case galvanically isolated from one another by at least one dielectric layer which can be produced by thermal spraying.

In one embodiment, the capacitor is formed with an at least substantially circular cross section and/or has a cylindrical cutout along a component axis.

Another embodiment provides a use of a capacitor as disclosed above for producing a power cable and/or a coaxial cable and/or a resonant heating line.

### BRIEF DESCRIPTION OF THE DRAWINGS

Example aspects and embodiments of the invention are described below with reference to the figures, in which:

FIG. 1 shows a schematic lateral sectional view of a cylindrical main body,

FIG. 2 shows the cylindrical main body after a ply of thermally sprayed ceramic and, flush-right, a ply of electrically conductive material have been applied,

FIG. 3 shows the structure as per FIG. 2, with a further dielectric layer and a ply of electrically conductive material applied flush-left,

FIG. 4 shows the structure from FIG. 3, in which a further ply of dielectric material and a further ply of electrically conductive material applied flush-left can be seen,

FIG. 5 shows the structure known from the previous figures after the main body has been removed,

FIG. 6 shows the layer system which has been shrunk by sintering and which forms the cylindrical capacitor, and

FIG. 7 shows a layer system 10 according to one embodiment of the present invention.

### DETAILED DESCRIPTION

Embodiments of the present invention provide a method for producing a capacitor which can be adapted as easily as possible to operation at high voltages, currents and temperatures and has an easily settable charge capacitance. Other embodiments provide a corresponding capacitor which can be adapted as easily as possible to extreme operating conditions. Still other embodiments provide a use of such a capacitor.

Some embodiments provide a method for producing a capacitor, in which at least the steps of a) providing a main body, b) producing a layer system on the main body, the layer system comprising at least two electrically conductive layers in each case galvanically isolated from one another by at least one dielectric layer, the at least one dielectric layer having at least one thermally sprayed layer of ceramic, and c) sintering the layer system, are carried out.

In other words, a capacitor is produced by producing two or more electrically conductive layers which act as electrodes in the finished capacitor. One or more isolating layers are arranged between in each case two electrically conductive layers and act as dielectric and isolate the electrically conductive layers from one another. According to some embodiments, the dielectric layers are applied at least partially by thermal spraying.

The carrier is then taken off or—for example by burning out—removed, as a result of which the still unsintered layer system is obtained.

The invention is not limited to the embodiments shown in the figures; both an electrically conductive layer and a dielectric layer can be applied to the main body as the first layer of the layer system.

It can similarly be provided in principle that a dielectric layer or an electrically conductive layer is produced as the last layer, i.e. as the top layer of the layer system.

The total number of layers of the layer system can be selected here as required. By way of example, the layer system can comprise 3, 4, 5, 6, 7, 8, 9, 10, 11, 12, 13, 14, 15, 16, 17, 18, 19, 20 or more layers, wherein each electrically conductive and/or dielectric layer in principle for its part can be made up of a plurality of layers of the same material or differing materials.

After the layer system has been produced, it is sintered, as a result of which the high-temperature-stable capacitor is obtained. In this case, the sintering temperature depends on the materials used and, by way of example, lies between 800° C. and 1800° C.

The capacitance of the capacitor produced as disclosed herein can be adapted particularly easily to the respective intended use thereof by varying the layer system and is determined essentially by the number and total surface area of the electrically conductive layers, by the number and thickness of the dielectric layers and by the permittivity of the dielectric layer(s) after the sintering. The thickness of the dielectric layer(s) additionally determines the electrical breakdown voltage of the capacitor and therefore represents a parameter which can be used to set the balance between capacitance and dielectric strength of the capacitor. The suitable selection of the materials and geometrical dimensions used makes it possible to achieve a high variability in terms of the capacitance and breakdown voltage of the capacitor. The disclosed method may allow production of capacitors with high charge capacitances up into the pF range which have a high temperature resistance and dielectric strength and are therefore also suitable for extreme operating conditions. Moreover, the geometry of the capacitor can be set particularly easily by way of the geometry of the main body, as a result of which the capacitor can be adapted particularly easily to different intended uses and can be integrated easily in an extremely wide variety of components. In one embodiment of the invention, it is provided that at least one dielectric layer is produced from at least two plies of thermally sprayed material and/or that the at least one ply of thermally sprayed material envelops the main body at least once to produce at least one dielectric layer. This represents a simple possibility for setting the capacitance of the capacitor in a targeted manner by way of the thickness of the dielectric, i.e. the thickness of the thermally sprayed layer, specifically by the number of plies. The thickness of the dielectric additionally determines the electrical breakdown voltage of the capacitor. By way of example, it can be provided that one, a plurality of or all dielectric layers each consist of 1, 2, 3, 4, 5, 6, 7, 8, 9, 10, 11, 12, 13, 14, 15 or more plies of a thermally sprayed material.

Thermal spraying is a method known per se for applying ceramic, metal oxide and/or carbidic material and encompasses a multiplicity of techniques, such as, for example, atmospheric plasma spraying, protective gas plasma spraying, plasma spraying in chambers, induction plasma spraying, liquid-stabilized plasma spraying, vacuum plasma spraying and plasma spraying at a pressure of above 1 bar. The invention is not limited to the aforementioned types of thermal spraying, however, but instead encompasses yet further types of thermal spraying which are not mentioned in more detail here.

To produce the electrically conductive layers, it is possible for metal powders, for example nickel powders, silver powders or other conductive powders, likewise to be applied by way of a thermal spraying method. In addition, the use of an organic paste containing metal particles is also suitable. This represents a particularly simple, fast and flexible possibility for producing the electrically conductive layers. The organic binder proportion can be burnt out during the sintering of the layer system, as a result of which the metal particles form a conductive sintered assembly for the electrodes. Elements such as, for example, silver and/or metal alloys can be used in principle as metal particles.

In a further embodiment, the electrically conductive layers are produced by immersion, knifecoating, imprinting and/or with the aid of a dipping process and/or a spraying process. This, too, makes it possible to produce the electrically conductive layers in a particularly fast, simple and flexible manner. The formation of the electrically conductive layer by metallization with thermal spraying methods as mentioned above, for example by atmospheric plasma spraying with metal powders such as with nickel powder and/or silver powder, is of course also provided. What are termed the APS (Atmospheric Plasma Spraying) method and the HVOF (High Velocity Oxide Fuel) method are also used here with particular preference.

Since the main body is removed from the layer system before the layer system is sintered, it is possible in a further embodiment to produce a recess or a cavity in the capacitor. This makes it possible for the capacitor to be integrated particularly easily into appropriately shaped components. Moreover, it is thereby possible to dispense with the use of high-temperature-resistant or sinterable main bodies and to reuse the main body for a renewed method run.

If use is made of a cylindrical main body, the dielectric layers can be produced particularly easily by spraying. The finished capacitor is then in the form of a cylindrical capacitor, which, during operation, affords the advantage that there is at least largely no electric field caused thereby in existence outside the capacitor. As an alternative or in addition, it has been found to be advantageous if use is made of a main body which has a surface with a coefficient of static friction of p<0.70, in particular a surface made of aluminum. A surface configuration of this nature makes it possible for the main body to be removed particularly easily before the layer system is sintered, such that, for example, a cylindrical main body can be pulled axially out of a correspondingly cylindrical layer system. In this respect, it can be provided in principle that the main body consists entirely of a material which is as smooth as possible, for example aluminum.

In a further embodiment, the electrically conductive layers are produced in such a manner that they make contact with the main body alternately on opposing sides of the main body. In other words, it is provided that the electrically conductive layers are embodied in such a way that a first electrically conductive layer extends down to the main body on one side of the layer system, but on the opposing side of the layer system is kept at a distance from the surface of the main body or from the edge of the dielectric layer. The second electrically conductive layer, which follows the first electrically conductive layer, has a converse form, such that the metallization is kept at a distance from the edge of the underlying dielectric layer on one side of the layer system and on the other side of the layer system extends down to the main body.

The same applies for all of the following electrically conductive layers. This forms a multi-ply capacitor in which the electrical contact surfaces lie on opposing sides of the layer system. Moreover, a comparatively thick electrically conductive layer is thereby formed on the main body, and this has an advantageous effect in terms of the current loading capacity of the capacitor.

In a further embodiment, the layer system is formed in a manner tapering radially outward proceeding from the main body. This can be achieved, for example, by varying the width of the dielectric layer, in order to ensure an uninterrupted lateral metallization of the layer system.

Further advantages arise in that, after sintering, the capacitor is integrated in a power cable and/or in a coaxial cable and/or in a resonant heating line. It is thereby possible to realize the specific advantages of the capacitor for different applications with high demands on the resistance of the capacitor to high voltages, currents and temperatures. If the capacitor is formed as a cylindrical capacitor, it can be integrated in a manner saving a particularly large amount of space in coaxial cables and/or resonant heating lines made up of alternating inductive and capacitive segments (e.g. for oil recovery).

Other embodiments provide a capacitor, e.g., a cylindrical capacitor, comprising a layer system, which has at least two electrically conductive layers in each case galvanically isolated from one another by at least one dielectric layer made of at least one sintered, thermally sprayed-on ceramic layer. The advantages discussed above with respect to the disclosed method may apply to the disclosed capacitor, and vice versa. In this respect, it has been found to be advantageous if the capacitor is obtainable and/or obtained by a method according to one of the preceding exemplary embodiments.

Further advantages arise if the capacitor is formed with an at least substantially circular cross section and/or has a cylindrical cutout along a component axis. As a result, the capacitor can be integrated particularly easily in cylindrical components such as, for example, power cables, coaxial cables and/or resonant heating lines. The cutout can also serve for the conduction of other lines, for example for the transportation of current, electrical signals or coolant.

Other embodiments relate to the use of a capacitor according to one of the preceding exemplary embodiments for producing a power cable and/or a coaxial cable and/or a resonant heating line. Advantages discussed above with respect to the disclosed method and disclosed capacitor may also apply to the use of such capacitor.

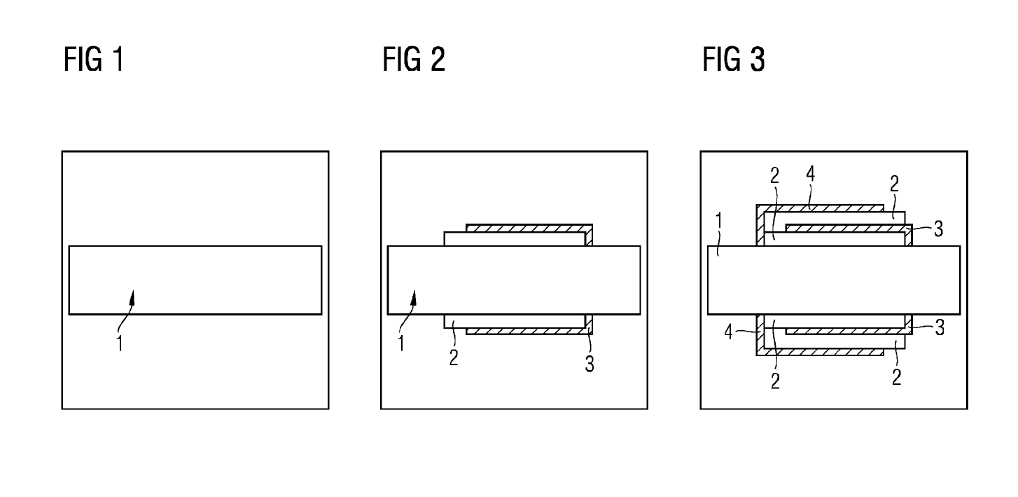

FIG. 1 shows a cross section through a cylindrical main body 1. This main body serves, for example, as a carrier for the layer system, which can be produced by thermal spraying and/or the application of a paste or of a dispersion. By way of example, this carrier can be made of metal, for example of graphite, a ceramic or a similar material which withstands the conditions which arise during the thermal spraying.

FIG. 2 shows the same view of the cylindrical main body 1 with a dielectric layer 2 formed thereon and an electrically conductive layer 4 applied flush-right. The dielectric layer 2 is preferably produced on the carrier 1 by way of thermal spraying with a precursor material which is conventional for this purpose, such as a metal oxide, a carbidic material or the like. The dielectric layer in this case is present, for example, in a thickness in the range of 10 μm to 900 μm, preferably in the range of 20 μm to 500 μm, and particularly preferably in the range of a few 10 μm to 190 μm, in particular in a thickness of approximately 100 μm. The figures are not true to scale, but it is preferably the case, as shown here, that the electrically conductive layer 3, irrespective of whether it is applied by thermal spraying or by way of a dispersion or paste, is somewhat thinner than the dielectric layer 2. The electrically conductive layer shown in FIG. 2 is applied flush-right, and therefore a conductive strip extends toward the carrier 1 on the right-hand side. For the thermal spraying, particular preference is given to the two techniques of the APS (Atmospheric Plasma Spraying) method and the HVOF (High Velocity Oxide Fuel) method. Both methods are distinguished by the fact that they can be carried out under simple atmospheric conditions (for example the presence of air, oxygen possible). Both the ceramic dielectric and the metallization can be sprayed in an air atmosphere and built up to form a three-dimensional component in an additive process.

By mechanically guiding the nozzle and turning the main body, it is possible here to realize a relatively homogeneous coating. In the same method, it is possible for the metallization to be applied in alternation, and therefore numerous handling steps which are routine, for example, in winding methods are omitted during the production method.

FIG. 3 shows the extended layer structure, wherein a first and a second ply of the dielectric layer 2, a first electrically conductive layer 3 applied flush-right and a second electrically conductive layer 4 applied flush-left can be seen on the main body 1.

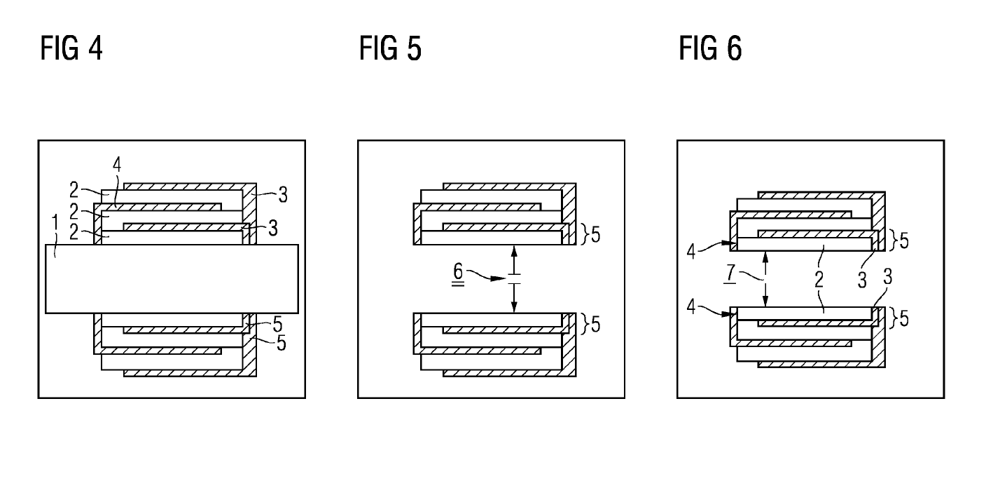

FIG. 4 shows a further dielectric layer 2 and a further electrically conductive layer 3 applied flush-right. The electrically conductive layers 3 are each extended as far as the main body 1, such that a region 5 in which there is a reinforced ply of electrically conductive material is formed there on the right. Since the metallization is drawn down either to the right or to the left as far as the carrier after each coating step, a region with a high metal thickness 5, for example, is formed in the vicinity of the roller. This has an advantageous effect in terms of the current loading capacity of the capacitor. For reasons of radial isolation inward and outward, the lower and upper electrode can be omitted. The capacitance of the component is determined by the overlapping circumferential surface of the electrode groups led out to the right or to the left, i.e. essentially the cylinder length; by the thickness of the dielectric layers; and by the permittivity of the ceramic after the sintering. The thickness of the dielectric likewise determines the electrical breakdown voltage of the component, i.e. represents the parameter which can be used to set the balance between capacitance and dielectric strength.

FIG. 5 shows the step of the method in which the main body 1 has been removed. Accordingly, what can be seen is a cross section through a cylindrical layer system which has an internal intersection 6.

FIG. 6 finally shows the shrunk layer system, which forms the capacitor and has a reduced internal diameter 7.

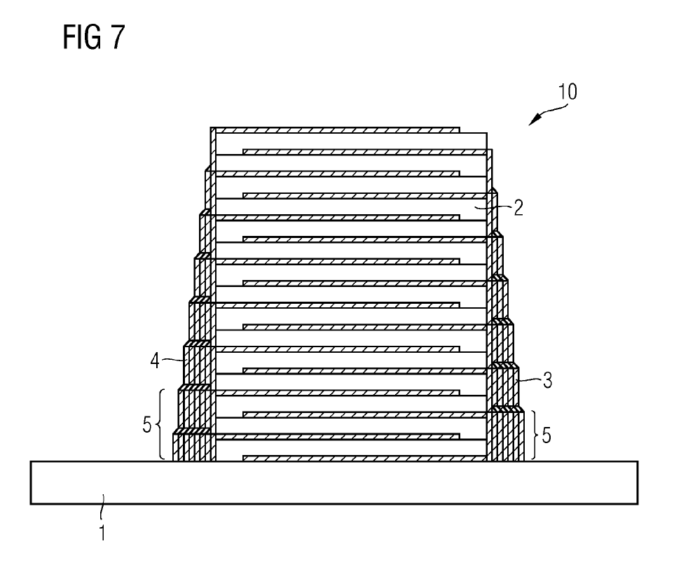

FIG. 7 finally shows a layer system 10 according to one embodiment of the present invention. The figure shows the regions 5 with a reinforced layer of conductive material 3 and 4, as well as the main body 1 and the layer sequence of the dielectric layers 2. Here, only one half of the cross section through a layer system of cylindrical construction can be seen.

The invention discloses for the first time a production method suitable for mass production of a capacitor, in particular a cylindrical capacitor. Here, a main body is coated with dielectric and electrically conductive layers in alternation by thermal spraying and/or spraying, and then sintered. In contrast to the prior art, this gives rise to a high variability in design with respect to the capacitance and breakdown voltage and temperature resistance.

What is claimed is:

1. A method for producing a capacitor, in particular a cylindrical capacitor, the method comprising:
providing a main body;
producing a layer system on the main body, the layer system comprising at least two electrically conductive layers galvanically isolated from one another by at least one dielectric layer comprising at least one ceramic ply applied by thermal spraying; and
sintering the layer system.

2. The method of claim 1, wherein the at least one dielectric layer extends around a circumference of the main body.

3. The method of claim 1, comprising applying the at least one dielectric layer by plasma spraying.

4. The method of claim 1, comprising applying at least one of the electrically conductive layers by thermal spraying.

5. The method of claim 1, comprising applying at least one of the electrically conductive layers as a conductive paste or a conductive dispersion.

6. The method of claim 1, comprising removing the main body before sintering the layer system.

7. The method of claim 1, comprising processing the layer system before sintering the layer system, but after removing the main body.

8. The method of claim 1, comprising structuring the layer system after removing the main body.

9. A cylindrical capacitor, comprising:
a layer system including at least two electrically conductive layers galvanically isolated from one another by at least one dielectric layer,
wherein the at least one dielectric layer are produced by thermal spraying.

10. The capacitor of claim 9, wherein the capacitor has at least one of (a) an at least substantially circular cross section or (b) a cylindrical cutout along a component axis of the capacitor.

11. A method for producing a cylindrical component, comprising:
forming a cylindrical component, and
integrating a capacitor in the cylindrical component, the cylindrical capacitor comprising a layer system including at least two electrically conductive layers galvanically isolated from one another by at least one dielectric layer formed by thermal spraying.

12. The method of claim 11, wherein the cylindrical component comprises a power cable, a coaxial cable, or a resonant heating line.

13. The method of claim 11, wherein:
the capacitor has a cylindrical cutout along an axis of the capacitor, and
the method further includes passing one or more conduit lines through the cylindrical cutout of the capacitor.
